(19) United States
(12) Patent Application Publication
(10) Pub. No.: US 2012/0298092 A1
(43) Pub. Date: Nov. 29, 2012

(54) METHOD FOR PRODUCING GEMSTONES FROM SILICON CARBIDE

(76) Inventors: Aleksandr V. Klishin, Moscow (RU); Jurij I. Petrov, Dzerzhinskij (RU); Viktor A. Tuzlukov, Vladivostok (RU)

(21) Appl. No.: 13/519,651

(22) PCT Filed: Aug. 18, 2011
(86) PCT No.: PCT/RU2011/000627

§ 371 Date: Jun. 28, 2012

(30) Foreign Application Priority Data
Oct. 28, 2010 (RU) 2010144123

(51) Int. Cl. B28D 5/00

(52) U.S. Cl. 125/30.01

(57) ABSTRACT

A method of producing gemstones from silicon carbide comprises growing simultaneously a plurality of moissanite crystal blanks in a graphite mold, splitting up the blanks into individual crystals, and faceting same. The plurality of grown blanks can be subjected to annealing to facilitate splitting. Faceting can comprise rough cutting, grinding and polishing. Prior to faceting, the blanks are attached to a mandrel with one side thereof. After faceting, the blanks are attached to a mandrel with their reverse side, and faceting is repeated. It is ensured that the depth of scratches be less than the length of a light wave in the visible part of the spectrum. The cut and cleaved edges and defective blanks unsuitable for faceting are pulverized and returned to the stage of growing.

### CROSS-REFERENCE TO RELATED APPLICATIONS

This application is a U.S. continuation-in-part National phase application of the International application PCT/RU2011/000627, filed Aug. 18, 2011 claiming priority to Russian application 2010144123, filed Oct. 28, 2010, the entire contents of each of the applications being hereby incorporated into the present application by reference in full.

### BACKGROUND OF THE INVENTION

### Field of the Invention

The invention relates to growing and processing monocrystals.

Silicon carbide (SiC) produced by the method of the present invention can be used not only for the electronic industry and jewelry-making but also as glass for watches, mobile telephones, eyewear, players and other accessories.

SiC (carborundum) is a binary inorganic compound of silicon and carbon. It occurs in nature in a very rare mineral called moissanite. Powdered SiC was first obtained in 1893. It is used in abrasives, semiconductors, synthetic precious stones. It is mostly used in abrasives but lately this material has been also used in semiconductors and for imitation of gem-quality diamonds.

When used in jewelry as a gem, SiC is called “synthetic moissanite” or simply “moissanite”. Moissanite is similar to diamond in that it is clear and hard (9-9.5 Mohs of hardness compared to 10 in diamond) and has a refraction index of 2.65-2.69 (compared to 2.42 in diamond). Moissanite has a somewhat more complicated structure than common cubic zirconium. In contrast to diamond, moissanite has a high birefringence. This feature may be desirable in some optic structures rather than in precious stones. For this reason, when manufacturing gems, the crystal is cut along the optic axis in order to minimize the birefringence effect. Moissanite has a lower density of 3.21 g/cm³ (versus 3.53 g/cm3 in diamond) and is far more thermally resistant. As a result, a gem is obtained with a strong brilliance, distinct faces and high environmental resistance. Unlike diamond which starts to burn at a temperature of 800° C., moissanite remains intact at temperatures up to 1800° C. (for comparison, 1064° C. is a melting temperature of pure gold). Moissanite has become popular as a diamond substitute and may be mistakenly taken for diamond since its thermal conductivity is far closer to that of diamond than in any other diamond substitute. Faceted moissanite may be distinguished from diamond judging by its birefringence and a very low-level of green or yellow fluorescence in the ultraviolet light. (O'Donoghue, M. Gems. Elsevier, 2006, page 89; ISBN 0-75-065856-8).

Known in the art are the methods for producing SiC, for example, in a polycrystalline form (RU 2327248 C30B 33/00, 2005) as well as in the form of monocrystals (RU 2156330 C30B 33/00, 2000).

### SUMMARY OF THE INVENTION

The method according to the invention differs from all prior art methods in simultaneously growing a plurality of monocrystals in a graphite mold whereby productivity increases since blanks are immediately obtained from cultivation so that the cutting operation is avoided, i.e., production costs and cutting-induced material losses are reduced.

The above effect is achieved by means of providing a method of simultaneous production of a plurality of precious stones from synthetic silicon carbide, i.e., moissanite, the method comprising growing simultaneously a plurality of moissanite crystal blanks in a honeycomb mold of molding graphite, separating the blanks into individual crystals, and faceting comprising three stages: rough cutting, grinding and polishing the crystals, wherein prior to faceting, the blanks are glued onto a mandrel with their one side and then—with the reverse side thereof, and polishing moissanite is carried out on a ceramic wheel rotating at a rate of 200 to 300 rpm using diamond powder spray with a grain size of 0.125-0.45 um to ensure that the depth of scratch marks be less than the length of a light wave in the visible part of the spectrum, and wherein the cut and cleaved edges and defective blanks unsuitable for faceting are pulverized and returned to the stage of growing.

Preferably, a grinding paste with a grain size of 0.25 μm is used for grinding.

### DETAILED DESCRIPTION OF THE INVENTION

According to the invention, the method of the production of precious stones from synthetic silicon carbide—moissanite is carried out as follows: a plurality of moissanite crystal blanks is simultaneously grown in a graphite mold. The method according to the present invention can provide for the following steps in crystal growing: controlling crystal nucleation by a conventional supersaturated vapor condensation onto seed monocrystals in a chamber, limiting crystallization rate in the initial stage by carrying it out in the inert atmosphere to thus suppress spontaneous crystal nucleation and growth, and degassing the chamber up to a substantially high vacuum level to thereby provide for the gradual increase of the growth rate up to several millimeters per hour. The seed monocrystals are selected from monocrystals of various polytypes, whereas the source of the material includes polycrystal silicon carbide synthesized from semiconductor-grade silicon and carbon. Growing crystals occurs from the seed including a silicon carbide disc 1 mm thick whose diameter is customarily about 2-3 inches. If a mold with openings is attached to the seed (the disc), the growth from the seed will proceed along the openings defined by walls. The shape of the openings can be different in shape (round, hexagonal, etc.). In other words, if a bottomless cup divided into two portions by a wall is “affixed” to the seed, after the growth it will result in two gem stone blanks, if divided into four portions—in four blanks. The after-growth product will constitute the original seed with the blanks grown thereon and spaced by forming graphite walls. Also, the number and shape of the blanks depend on the diameter of the seed and required blank size, defined in turn by the shape of cutting, required sizes of the gems including allowance for cutting, and the thickness of the forming graphite walls.

When grown, the blanks are split into individual crystals. To facilitate splitting, the forming graphite walls are burn out in the course of annealing in the presence of oxygen at about 1000-1200° C. during 4-6 hours. The annealing at the indicated conditions removes carbon and decreases the strength of the “composite complex” of seed—carbon (the forming graphite walls)—blank, not affecting the strength of the silicon carbide blanks themselves. Then, the blanks are successively rough cut, ground, and polished, the operations being performed as follows: each separated blank is glued onto a metal mandrel, the free side of the blank being processed by way of rough cutting grinding, and polishing, then the processed side of the blank is glued onto another mandrel, and the operations of rough cutting, grinding and polishing are repeated on the remaining side. The blanks are polished on ceramic wheels rotating at a rate of 200 to 300 rpm, with the use of diamond powder (spray) with a grain size of 0.125-0.45 μm to ensure that the depth of scratch marks be less than the length of a light wave in the visible part of the spectrum. The cut and cleaved edges, as well as defective blanks unsuitable for faceting are pulverized and returned to the growing stage.

Preferably, a diamond grinding paste with a grain size of 5-10 μm is used for grinding.

The method is further illustrated by the following examples.

### EXAMPLE 1

A plurality of moissanite crystal blanks was simultaneously grown in a honeycomb graphite mold. The grown crystals were separated into individual blanks. Faceting was carried out comprising three stages: rough cutting, grinding and polishing, the blanks being in advance glued onto a special mandrel. Then, the blanks were re-glued onto the reverse side thereof, and processed similarly. The operation of polishing moissanite was carried out on a steel wheel rotating at a rate of 200 rpm using a grinding paste with a grain size of 0.25 μm, the cut and cleaved edges and defective blanks unsuitable for faceting being pulverized and returned to the stage of growing.

### EXAMPLE 2

A plurality of moissanite crystal blanks was simultaneously grown in a honeycomb graphite mold. The grown crystals were separated into individual blanks. Prior to faceting, blanks were glued with the base thereof onto a special mandrel, and then with the reverse side thereof and faceted again. Those moissanite blanks were polished on a steel wheel rotating at a rate of 280 rpm using a grinding paste with a grain size of 0.45 μm, the cut and cleaved edges and defective blanks unsuitable for faceting being pulverized and returned to the stage of growing.

### EXAMPLE 3

All stages were performed as those in Example 2, except for using the grinding paste with the grain size of 0.25 μm.

The resulting monocrystals are suitable for use in jewelry-making.

It should be noted that faceting of diamond and moissanite differs in that diamond becomes very hot during faceting and for that reason it is mechanically gripped in the collet of the faceting head, while moissanite is simply glued to a metal mandrel using a hot-melt glue.

Diamonds are cut on the heavy cast-iron wheel at a rate of 3000 rpm and more, wherein both cutting and polishing are performed on the same wheel. In contrast, faceting moissanite comprises three stages: rough cutting, grinding and polishing which are performed on different wheels at a far lower rotation rate.

The production of faceted jewelry inserts by the present method comprises a number of stages. If needed, an obtained sample of silicon carbide is subject to coarse finishing (rough cutting). This stage is carried out on abrasive wheels with the grain size of 20 to 100 tm depending on the blank size and the quantity of materials to be ground down. Rough cutting results in obtaining to-be-faceted inserts of the appropriate shape.

In order to bring the insert faces to each other more precisely, an optional intermediate processing may be then performed on grinding or cutting wheels with the abrasive grain size of 3-10 μm. A finer grinding, i.e., polishing the faces of the faceted inserts, according to the present method is accomplished using fine grained abrasives with the grain size of 0.125-0.5 to avoid forming multiple scratches, whose depth is commensurate with the length of a light wave in the visible part of the spectrum. In this, there lies one more difference from the prior art where an abrasive with the grain size of 0.5-3 μm is used for polishing. The rotation rate of the polishing wheel should not be high (about 200-300 rpm) and the pressing force of the insert to the wheel surface should be low to avoid rounding of edges and surface warp of faces.

The above stages are performed for all faces on one side of the insert (top or bottom) and then repeated for the opposite side.

It is a common faceting practice to use for polishing the abrasive powder (spray, paste, emulsion, etc.) comprising grains of diamond, metal oxides or other hard materials with the grain size of 0.5 μm or more. However, the grains of such size may leave multiple scratches commensurate in depth so that the light flux will partially scatter. To the contrary, faceted inserts produced by the present method are polished with abrasive powders with the grain size of 0.125-0.25 μm so that, subject to adherence to polishing technique, the required surface finish (corresponding to the 11^{th} grade of finish according to GOST 2789-59) is enabled, and scattering of the light flux is avoided. In this case, depending on the angle of incidence, the light incident on the facet surface either reflects or penetrates whereby it is refracted and contributes to the internal reflection facilitating the stellar shining effect to occur. In other words, if the depth of the scratches is less than the length of a light wave in the visible part of the spectrum (0.4 μm), these scratches have no pronounced effect on the path of incident rays. If the scratches become deeper, the light flux hitting the same slightly scatters so that the color flashing (change of color, shine) becomes less pronounced.

Accordingly, the product quality improves.

It should be also noted that the present method results in reduced production costs of silicon carbide articles through recycling of the material unsuitable for faceting.

1-2. (canceled)

3. A method of producing moissanite gems from synthetic silicon carbide, said method comprising the steps of:
growing simultaneously a plurality of moissanite crystal blanks in a graphite mold,
splitting up said blanks into individual crystals, and
faceting said individual crystals.

4. The method as claimed in claim 3, further comprising annealing said grown plurality of blanks in the presence of oxygen at 1000-1200° C. during 4-6 hours, whereby carbon of said graphite mold separating said blanks is burn out and said splitting up said blanks into said individual crystals is thus facilitated.

5. The method as claimed in claim 3, wherein cut and cleaved edges of the faceted crystals and defective blanks unsuitable for faceting are pulverized and returned to the stage of growing.

6. The method as claimed in claim 3, wherein said faceting is performed by first attaching said individual crystals to a mandrel with a face or reverse side thereof, and processing exposed sides of the individual crystals, and then by attaching said individual crystals to the mandrel with a reverse or face side thereof and processing exposed sides of the individual crystals.

7. The method as claimed in claim 3, wherein said faceting is performed by processing the individual crystals on a ceramic wheel using diamond spray.

8. The method as claimed in claim 7, wherein said ceramic wheel is given rotation at a rate of about 200 to 300 rpm and said diamond spray has a grain size of 0.125-0.45 μm so that the depth of scratches resulting from said processing be less than the length of a light wave in the visible part of the spectrum.

9. The method as claimed in claim 7, wherein said faceting additionally comprises rough cutting the individual crystals, said rough cutting preceding said processing and being performed on an abrasive wheel with a grain size of 20-100 μm.

10. The method as claimed in claim 7, wherein said faceting additionally comprises grinding the individual crystals, said grinding preceding said processing and being performed on a grinding wheel with a grain size of 3-10 μm with the use of a grinding paste with a grain size of 0.25 μm.

11. A method of producing moissanite gems from synthetic silicon carbide, said method comprising the steps of:
growing simultaneously a plurality of moissanite crystal blanks in a graphite mold,
annealing said grown plurality of blanks in the presence of oxygen at 1000-1200° C. during 4-6 hours, to thereby burn out carbon of said graphite mold separating said blanks,
splitting up said blanks into individual crystals,
attaching said individual crystals onto a mandrel with a face or reverse side thereof, and faceting exposed sides of the individual crystals,
attaching said individual crystals onto the mandrel with a reverse or face side thereof and faceting exposed sides of the individual crystals.

12. The method as claimed in claim 11, wherein cut and cleaved edges of the processed crystals and defective blanks unsuitable for faceting are pulverized and returned to the stage of growing.

13. The method as claimed in claim 11, wherein said faceting comprises:
rough cutting the individual crystals, said rough cutting being performed on an abrasive wheel with a grain size of 20-100 μm,
grinding the individual crystals, said grinding being performed on a grinding wheel with a grain size of 3-10 μm with the use of a grinding paste with a grain size of 0.25 μm, and
processing the individual crystals on a ceramic wheel rotating at a rate of about 200 to 300 rpm and using diamond spray with a grain size of 0.125-0.45 μm,
to thereby warrant that the depth of scratches resulting from said processing be less than the length of a light wave in the visible part of the spectrum.

14. The method as claimed in claim 11, wherein said growing simultaneously a plurality of moissanite crystal blanks comprises the steps of:
providing at least one seed crystal,
attaching the at least one seed crystal to the graphite mold,
placing the graphite mold with the seed into a chamber,
controlling crystal nucleation by condensing supersaturated vapor onto the at least one seed crystal in the chamber,
limiting crystallization rate in the initial stage by carrying it out in the inert atmosphere to thus suppress spontaneous crystal nucleation and growth, and
degassing the chamber up to a substantially high vacuum level to thereby provide for the gradual increase of the growth rate.

15. The method as claimed in claim 14, wherein said at least one seed crystal includes an about 1 mm thick disc with diameter of about 2-3 inches.

16. The method as claimed in claim 14, wherein said graphite mold is made with openings defined by walls along which the growth from the seed proceeds.

17. The method as claimed in claim 14, wherein cut and cleaved edges of the processed crystals and defective blanks unsuitable for faceting are pulverized and returned to the stage of growing.

18. A method of producing moissanite gems from synthetic silicon carbide, said method comprising the steps of:
providing at least one seed crystal,
growing simultaneously a plurality of moissanite crystal blanks out of the at least one seed crystal in a graphite mold,
annealing said grown plurality of blanks in the presence of oxygen at 1000-1200° C. during 4-6 hours, to thereby burn out carbon of said graphite mold separating said blanks,
splitting up said blanks into individual crystals, and
faceting the individual crystals,
said faceting being performed by successively
rough cutting the individual crystals, said rough cutting being performed on an abrasive wheel with a grain size of 20-100 μm,
grinding the individual crystals, said grinding being performed on a grinding wheel with a grain size of 3-10 μm with the use of a grinding paste with a grain size of 0.25 μm, and
processing the individual crystals on a ceramic wheel rotating at a rate of about 200 to 300 rpm and using diamond spray with a grain size of 0.125-0.45 μm,
to thereby warrant that the depth of scratches resulting from said processing be less than the length of a light wave in the visible part of the spectrum.

19. The method as claimed in claim 18, wherein said faceting comprises
attaching said individual crystals onto a mandrel with a face or reverse side thereof, and faceting exposed sides of the individual crystals, and
attaching said individual crystals onto the mandrel with a reverse or face side thereof and faceting exposed sides of the individual crystals.

20. The method as claimed in claim 18, wherein cut and cleaved edges of the processed crystals and defective blanks unsuitable for faceting are pulverized and returned to the stage of growing.
